(19) United States
(12) Patent Application Publication
(10) Pub. No.: US 2014/0132898 A1
(43) Pub. Date: May 15, 2014

(54) DISPLAY PANEL AND DISPLAY DEVICE

(71) Applicant: BOE TECHNOLOGY GROUP CO., LTD., Beijing (CN)

(72) Inventors: Guangkui Qin, Beijing (CN); Jae Geon You, Beijing (CN)

(73) Assignee: BOE TECHNOLOGY GROUP CO., LTD., Beijing (CN)

(21) Appl. No.: 14/076,542

(22) Filed: Nov. 11, 2013

(30) Foreign Application Priority Data
Nov. 12, 2012 (CN) 2012 104 52116.X

(51) Int. Cl. G02F 1/1335

(52) U.S. Cl. CPC G02F 1/133536; G02F 1/133555
USPC 349/103; 349/96

(57) ABSTRACT

The invention discloses a display panel, which comprises a liquid crystal cell, an upper polarizer sheet arranged above the liquid crystal cell, a lower polarizer sheet arranged under the liquid crystal cell and a transflective film arranged under the lower polarizer sheet. The invention further discloses a display device comprising the above display panel. By the invention, not only the transflective display has an improved effect, but also the transflective display has a simple structure and an inexpensive cost in comparison with the existing transflective display mode.

### RELATED REFERENCE

This application claims priority from China Patent Application No. 20120452116.X, filed on Nov. 12, 2012, which is also hereby incorporated herein by reference.

### BACKGROUND OF THE INVENTION

1. Field of the Invention

The present invention relates to the technical field of displays, and in particular, to a display panel and a display device.

2. Description of the Prior Art

Transflection technology arises gradually in the 21^{st} century. The main reason lies in that the transmissive mode and the reflective mode have respective advantages and disadvantages, while the transflective display mode integrates the advantages thereof.

Reflective Screen: there exists a reflecting mirror on the back of the screen, for providing a light source for reading under sunlight and lamplight, it has the advantage of an excellent performance under a strong light source such as outdoor sunshine, and it has the disadvantage of being unclear or unable to read under a dim light or under a lightless condition.

Transmissive Screen: there exists no reflecting mirror on the back of the screen, and a light source is provided by a back light, it has the advantage of great readability under a dim light or under a lightless condition, and it has the disadvantage that the luminance of the backlight under outdoor sunlight is severely insufficient. Moreover, the electricity quantity will be lost rapidly and the effect thereof will be worse just by improving the luminance of the back light.

Transflective Screen: the reflecting mirror on the back of the reflective screen is replaced by a specularly reflecting film, and a Transmission-type backlight is added. The specularly reflecting film is transflective, it is a mirror when seen from its front face, and it is a transparent glass when seen from its back face. It can be said that a transflective screen is a hybrid of a reflective screen and a transmissive screen, which has the advantages of the reflective screen and the transmissive screen, that is, the great readability of the reflective screen under outdoor sunlight and the excellent readability of the transmissive screen under a dim light and a lightless condition.

The structure of a traditional transflective display panel is as shown in FIG. 1, which comprise a lower polarizer sheet 101, a first quarter wave plate 102, a liquid crystal cell, second quarter-wave plate 106 and an upper polarizer sheet 107 that are laminated in turn, wherein the liquid crystal cell is constituted of an array substrate 103, a color film substrate 105 and a liquid crystal layer 104 assembled between the array substrate 103 and the color film substrate 105. Each of pixels of the liquid crystal cell is divided into a transmissive region and a reflective region, and a reflecting plate 108 is provided in the area corresponding to the reflective region in the liquid crystal cell. Because a reflecting plate is provided in the liquid crystal cell, the process for producing the display panel will be complex and expensive, and the display effect will be poor.

### SUMMARY OF THE INVENTION

### Technical Problem to be Solved

The technical problem to be solved by the invention is to provide a display panel and a display device having a good display effect. The process for producing the display panel is simple and economy.

### Technical Solutions

To solve the above problem, in one aspect of the invention, there provides a display panel, which comprises a liquid crystal cell, an upper polarizer sheet arranged above the liquid crystal cell, a lower polarizer sheet arranged under the liquid crystal cell and a transflective film arranged under the lower polarizer sheet.

The “above” refers to that the parts from which the emitting light of the backlight passes through first is above the parts from which the emitting light of the backlight passes through secondly under at the emitting light of backlight as reference. The “under” refers to that the parts from which the emitting light of the backlight passes through secondly is under the parts from which the emitting light of the backlight passes through first at the emitting light of backlight as reference.

Preferably, the transflective film comprises a first reflective polarizer sheet, wherein an included angle formed between transmission axis of the first reflective polarizer sheet and transmission axis of the lower polarizer sheet is an acute angle.

Preferably, the transflective film comprises a phase retardation plate and a second reflective polarizer sheet under the phase retardation plate.

Preferably, the phase retardation plate is an adjustable phase retardation plate having adjustable the phase retardation value and/or the optical axis direction.

Preferably, the transmission axis of the second reflective polarizer sheet is parallel to or vertical to the transmission axis of the lower polarizer sheet.

The transmission axis of the second reflective polarizer sheet is parallel to the transmission axis of the lower polarizer sheet, optical axis of the phase retardation plate and the transmission axis of the second reflective polarizer sheet form an angle of 45°, and a mode conversion between a full transmissive mode, a transflective mode and a full reflective mode can be achieved in the display panel by controlling the phase retardation value of the phase retardation plate.

When R is equal to n λ, the display panel is in the full transmissive mode; when R is equal to (2n+1) λ/2, the display panel is in the full reflective mode; when R is greater than nλ and less than (2n+1) λ/2, or greater than (2n+1) λ/2 and less than (n+1) λ, the display panel is in the full transflective mode; wherein R represents the phase retardation value of the phase retardation plate, λ represents wavelength of incident light, and n represents 0 or a positive integer.

The transmission axis of the second reflective polarizer sheet is parallel to the transmission axis of the lower polarizer sheet, the phase retardation value of the phase retardation plate is an odd multiple of one-half wavelength, and a mode conversion between the full transmissive mode, the transflective mode and the full reflective mode can be achieved in the display panel by adjusting the optical axis direction of the phase retardation plate.

when the optical axis of the phase retardation plate and the transmission axis of the second reflective polarizer sheet form an angle of 0° or 90°, the display panel is in a full transmissive mode; when the optical axis of the phase retardation plate and the transmission axis of the second reflective polarizer sheet form an angle of is 45°, the display panel is in the full reflective mode; and when the optical axis of the phase retardation plate and the transmission axis of the second reflective polarizer sheet form an angle of is greater than 0° and less than 45°, or greater than 45° and less than 90°, the display panel is in transflective mode.

The transmission axis of the second reflective polarizer sheet is vertical to the transmission axis of the lower polarizer sheet, the optical axis of the phase retardation plate and the transmission axis of the second reflective polarizer sheet form an angle of 45°, and a mode conversion between the full transmissive mode, the transflective mode and the full reflective mode can be achieved in the display panel by controlling the phase retardation value of the phase retardation plate.

When R is equal to nλ, the display panel is in the full reflective mode; when R is equal to (2n+1) λ/2, the display panel is in the full transmissive mode; when R is greater than nλ and less than (2n+1) λ/2, or greater than (2n+1) λ/2 and less than (n+1) λ, the display panel is in the full transflective mode; wherein R represents the phase retardation value of the phase retardation plate, λ represents the wavelength of incident light, and n represents 0 or a positive integer.

The transmission axis of the second reflective polarizer sheet is vertical to the transmission axis of the lower polarizer sheet, the phase retardation value of the phase retardation plate is an odd multiple of one-half wavelength, and a mode conversion between the full transmissive mode, the transflective mode and the full reflective mode can be achieved in the display panel by adjusting the optical axis direction of the phase retardation plate.

when the optical axis of the phase retardation plate and the transmission axis of the second reflective polarizer sheet form an angle of 0° or 90°, the display panel is in the full reflective mode; when the optical axis of the phase retardation plate and the transmission axis of the second reflective polarizer sheet form an angle of is 45°, the display panel is in the full transmissive mode; and when the optical axis of the phase retardation plate and the transmission axis of the second reflective polarizer sheet form an angle of is greater than 0° and less than 45°, or greater than 45° and less than 90°, the display panel is in the transflective mode.

Preferably, the transflective film is made of a polymer dispersed liquid crystal.

Preferably, a third reflective polarizer sheet is further provided between the transflective film and the lower polarizer sheet, and the transmission axis of the third reflective polarizer sheet is parallel to the transmission axis of the lower polarizer sheet.

In another aspect of the invention, there further provides a display device comprising the above display panel.

### Beneficial Effect

In the invention, a transflective display is realized without changing the structure of the traditional liquid crystal cell, thus not only the transflective display has an improved effect, for example, without the problems of poor visual angle and low contrast, while with an effect the same as or better than that of a general transmissive mode and a good stability in outdoor, but also the transflective display has a simple structure and an inexpensive cost in comparison with the existing transflective display mode.

The invention is not limited by the liquid crystal mode and may be realized in any liquid crystal mode (for example, FFS, VA, IPS, TN and ECB modes), so that the display panel can be widely used.

### BRIEF DESCRIPTION OF THE DRAWINGS

FIG. 1 is a schematic diagram showing a laminate structure of a transflective display panel in the prior art

FIG. 2 is a schematic diagram showing a laminate structure of a display panel according to Embodiment 1 of the invention;

FIG. 3 is a schematic diagram showing a laminate structure of a display panel according to Embodiment 2 of the invention;

FIG. 4 is a schematic diagram showing a laminate structure of a display panel according to Embodiment 3 of the invention; and

FIG. 5 is a schematic diagram showing a laminate structure of a display panel according to Embodiment 4 of the invention.

### DETAILED DESCRIPTION OF THE PREFERRED EMBODIMENTS

The invention will be illustrated in detail below in conjunction with the drawings and embodiments.

The invention records a display panel, which comprises a liquid crystal cell, an upper polarizer sheet arranged above the liquid crystal cell, a lower polarizer sheet arranged under the liquid crystal cell and a transflective film arranged under the lower polarizer sheet.

The “above” refers to that the parts from which the emitting light of the backlight passes through first is above the parts from which the emitting light of the backlight passes through secondly under at the emitting light of backlight as reference. The “under” refers to that the parts from which the emitting light of the backlight passes through secondly is under the parts from which the emitting light of the backlight passes through first at the emitting light of backlight as reference.

It may be seen that, in the invention, because no reflecting plate is provided in the liquid crystal cell and the transflective display of a liquid crystal panel is realized via a transflective film under the lower polarizer sheet, on one hand, it is no need to change the structure of the traditional liquid crystal cell so as to reduce the cost of the transflective display panel; on the other hand, the transflective liquid crystal panel of the invention is not limited by the liquid crystal mode and may be realized in any liquid crystal mode (for example, FFS, VA, IPS, TN and ECB modes), so that the display panel can be widely used.

Specifically:

### Example 1

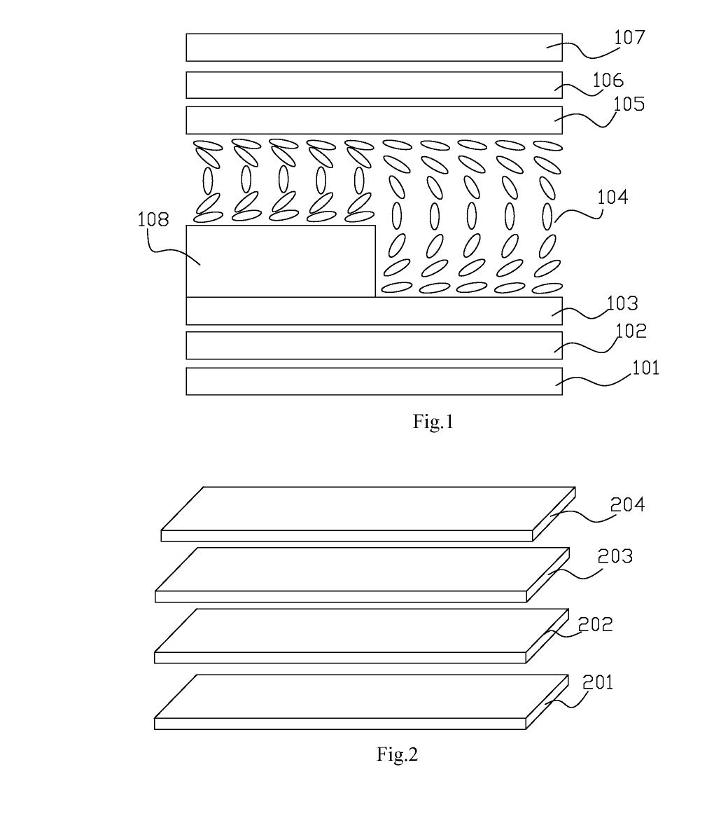

As shown in FIG. 2, it records a display panel, which comprises a liquid crystal cell 203, an upper polarizer sheet 204 arranged above the liquid crystal cell 203 and a lower polarizer sheet 202 arranged under the liquid crystal cell 203. In this Example, the display panel further includes a transflective film 201 arranged under the lower polarizer sheet 202, In this Example or in all other examples below, the definitions of “above” and “under” are the same as those the above.

In this embodiment, the transflective display of a display panel is realized by replacing a reflecting layer inside the liquid crystal cell 203 of the prior art with a transflective film 201 under the liquid crystal cell 203, thus the structure of a transflective display-mode display panel and a process for produce the same will be simpler and inexpensive.

In this Example, the transflective film 201 may be a general transflective film, for example, a thin film coated with a very thin layer of metal aluminum; and the required transmission-reflection ratio may be obtained by selecting thin films with different thicknesses according to design requirements. Wherein, there exist two extreme cases: when the thickness of the thin film reaches a certain extent, the thin film will be no longer light transmissive, so that a full reflection will be realized; when the thickness of the thin film is equal to 0, no reflection occurs almost, so that a full transmission will be realized.

The “transmission-reflection ratio” refers to the rate of the transmitted light to the reflected light when lights reach the transflective film.

In other Example of the invention, the transflective film may also be a thin film with an adjustable transmission-reflection ratio, for example, the transflective film made of a polymer dispersed liquid crystal (PDLC). When no power is applied, the PDLC is in scatter state, that is, it is both transmissive and reflective, so that the transflective mode is realized. when a voltage is applied, the transparency of the PDLC will be improved gradually, that is, the proportion of transmission will be improved, and the proportion of reflection will be reduced.

### Example 2

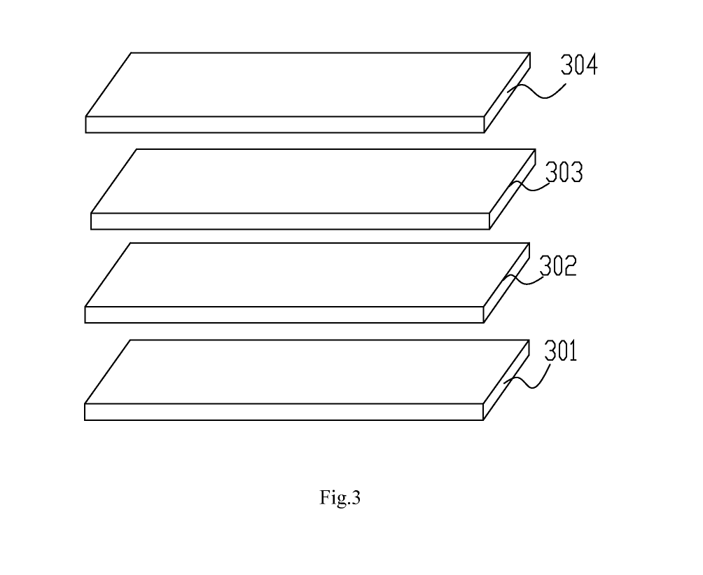

As shown in FIG. 3, this Example records a display panel, which comprises an upper polarizer sheet 304, a liquid crystal cell 303, a lower polarizer sheet 302 and a transflective film, wherein the upper polarizer sheet 304, the liquid crystal cell 303, the lower polarizer sheet 302 and the transflective film are arranged in turn from top to bottom. In this Example, the transflective film comprises a first reflective polarizer sheet 301, the included angle between the transmission axis of the first reflective polarizer sheet 301 and the transmission axis of the lower polarizer sheet 302 is an acute angle, that is, the transmission axis of the first reflective polarizer sheet 301 is neither vertical to nor parallel to the transmission axis of the lower polarizer sheet 302. The reflective polarizer sheet may allow a linearly polarized light with a polarization direction parallel to the transmission axis thereof to be transmitted, and allow a linearly polarized light with a polarization direction vertical to the transmission axis thereof to be reflected, so that the transflective mode is realized. According to design requirements, a required transmission-reflection ratio may be obtained by adjusting the transmission axis direction of the first reflective polarizer sheet 301. By setting different the transmission axis directions of the first reflective polarizer sheet 301, different display modes may be realized. Specifically, when the transmission axis of the first reflective polarizer sheet 301 is parallel to the transmission axis of the lower polarizer sheet, the display mode will be full transmissive mode; when the transmission axis of the first reflective polarizer sheet 301 is vertical to the transmission axis of the lower polarizer sheet, the display mode will be full reflective mode; and when the transmission axis of the first reflective polarizer sheet 301 is neither parallel to nor vertical to the transmission axis of the lower polarizer sheet (i.e., the included angle therebetween is an acute angle), the display mode will be the transflective mode.

### Example 3

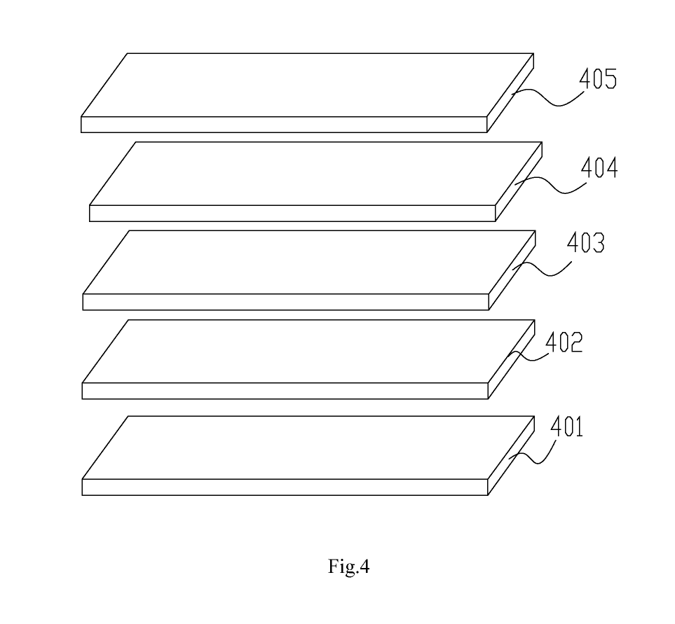

As shown in FIG. 4, this Example records a display panel, which comprises an upper polarizer sheet 405, a liquid crystal cell 404, a lower polarizer sheet 403 and a transflective film, wherein the upper polarizer sheet 405, the liquid crystal cell 404, the lower polarizer sheet 403 and the transflective film are arranged in turn from top to bottom.

In this Example, the transflective film comprises a phase retardation plate 402 and a second reflective polarizer sheet 401 under the phase retardation plate 402. The second reflective polarizer sheet 401 has a property of being transflective. In this Example, a reflected light and a transmitted light that are reflected and transmitted by the second reflective polarizer sheet 401 are both linearly polarized lights, the polarization directions thereof are vertical to each other, the phase retardation plate 402 and the second reflective polarizer sheet 401 are provided under the lower polarizer sheet 403, and the reflection-transmission proportion of the display panel is controlled by controlling the polarization property of the transmitted light and the reflected light by the phase retardation plate 402, so that the transflective effect may be attained without the need to change the structure of the traditional liquid crystal cell 404. Moreover, the process for manufacturing the display panel is simple, and the display panel has a good display effect.

In this Example, for the phase retardation plate 402, the phase retardation value and/or the optical axis direction are adjustable. The proportion of the transmitted light to the reflected light of the display panel is adjusted by adjusting the phase retardation value and/or the optical axis direction of the phase retardation plate 402. However, in other Example of the invention, the phase retardation value and the optical axis of the phase retardation plate 402 may also be fixed, the transflective effect via a simple structure can also be realized, except for adjusting the transmission-reflection ratio flexibly.

In this Example, the transmission axis of the second reflective polarizer sheet 401 is parallel to or vertical to the transmission axis of the lower polarizer sheet 403, thus it will be more convenient to adjust the proportion of the transmitted light to the reflected light, and the full reflective display effect and the full transmissive display effect may be attained.

For the display panel according to this Example, the proportion of the transmitted light to the reflected light of the display panel may be adjusted by adjusting at least one selected from the phase retardation value and the optical axis direction of the phase retardation plate 402. That is, the proportion of the transmitted light to the reflected light of the display panel may be adjusted by the following three methods: 1) in the case that the optical axis of the phase retardation plate 402 is fixed, it may be realized by controlling the phase retardation value thereof; 2) in the case that the phase retardation value is fixed, it may be realized by controlling the optical axis direction thereof; 3) it may be realized by adjusting the phase retardation value and the optical axis direction of the phase retardation plate 402 at the same time.

This embodiment will be illustrated below in four specific cases:

1. The transmission axis of the second reflective polarizer sheet 401 is kept parallel to the transmission axis of the lower polarizer sheet 403 of the display panel, the angle between the optical axis of the phase retardation plate 402 and the transmission axis of the second reflective polarizer sheet 401 is 45°, and the transmission-reflection ratio of the display panel is adjusted by controlling the phase retardation value of the phase retardation plate 402, thereby the mode conversion (comprising the full transmissive mode, the transflective mode and the full reflective mode) can be achieve. In this Example, when the phase retardation value of the phase retardation plate 402 is equal to 0 or an integral multiple of the wavelength (i.e. R=nλ), the display panel will be in the full transmissive mode (preferably, the phase retardation value is equal to 0); when the phase retardation value is an odd multiple of one-half wavelength (i.e. R=(2n+1)λ/2, preferably, R is one-half wavelength), the display panel will be in the full reflective mode; and when the phase retardation value is a value other than the above two cases (i.e. nλ<R<(2n+1)λ/2 or (2n+1)λ/2<R<(n+1)λ/2), the display panel will be in the transflective mode and the transmission-reflection proportion will be determined by the phase retardation value; wherein R represents the phase retardation value of the phase retardation plate, λ represents the wavelength of incident light, and n represents 0 or a positive integer.

The operating principle thereof will be as follows: when the outside ambient light is strong, only a linearly polarized light with a polarization state parallel to the transmission axis of the lower polarizer sheet 403 in the ambient light can be transmitted downward through the lower polarizer sheet 403, and then the polarized light will pass through the phase retardation plate 402, of which the optical axis and the polarization direction of the polarized light form an included angle of 45°. At this point, the following three methods for adjusting the phase retardation value of the phase retardation plate are shown: 1) When the phase retardation value of the phase retardation plate 402 is equal to 0 or an even multiple of one-half wavelength, and a light through the lower polarizer sheet 403 passes through the phase retardation plate 402 at the time, the polarization direction thereof will not be changed, thus it will directly pass through the reflective polarizer sheet below. Similarly, when a light from a backlight source reaches the second reflective polarizer sheet, a linearly polarized light with a polarization direction parallel to the transmission axis of the second reflective polarizer sheet may be transmitted, and at this point, the linearly polarized light may also directly pass through the phase retardation plate and the lower polarizer sheet, so that the full transmission may be realized without any reflection. 2) When the phase retardation value of the phase retardation plate 402 is an odd multiple of one-half wavelength (preferably, one-half wavelength), the polarization direction of a linearly polarized light through a phase retardation plate will be rotated by 90°, and at this point the polarization direction of the polarized light will be just vertical to the transmission axis of the second reflective polarizer sheet 401 below, and the light will be fully reflected, then it passes through the phase retardation plate 402 again and is again rotated by 90°, the polarization direction of the linearly polarized light will be parallel to the transmission axis of the below polarizer sheet at this point, so that the light will be fully transmitted. At the same time, in the light from a backlight source, only a linearly polarized light with a polarization direction parallel to the transmission axis of the second reflective polarizer sheet may be transmitted through the second reflective polarizer sheet. When the linearly polarized light passes through the phase retardation plate, the polarization direction will be rotated by 90°, and the polarization direction of the linearly polarized light will be vertical to the transmission axis of the lower polarizing plate at this point, thus it cannot be transmitted through the lower polarizer sheet, thereby the full reflective mode may be realized. 3) When the phase retardation value of the phase retardation plate 402 is a value other than 0, an even multiple of one-half wavelength and an odd multiple of one-half wavelength, the transflective mode with both transmission and reflection may be realized.

2. The transmission axis of the second reflective polarizer sheet 401 is kept parallel to the transmission axis of the lower polarizer sheet 403 of the display panel, the phase retardation value of the phase retardation plate 402 is equal to an odd multiple of one-half wavelength (preferably, one-half wavelength), and the transmissive and reflective state and the transmission-reflection proportion are realized by controlling the optical axis direction of the phase retardation plate 402, thereby the mode conversion (comprising the full transmissive mode, the transflective mode and the full reflective mode) can be achieve. In this Example, when the optical axis of the phase retardation plate and the transmission axis of the second reflective polarizer sheet form an angle of 0° or 90°, the display panel will be in the full transmissive mode; when the optical axis of the phase retardation plate and the transmission axis of the second reflective polarizer sheet form an angle of 45°, the display panel will be in the reflective mode; when the optical axis of the phase retardation plate and the transmission axis of the second reflective polarizer sheet form an angles of the degree other than 0°, 45° and 90°, the display panel will be in the transflective mode, and the transmission-reflection proportion will be determined by the size of the angle.

The operating principle thereof will be as follows. When the outside ambient light is strong, only a linearly polarized light with a polarization state parallel to the transmission axis of the lower polarizer sheet 403 in the ambient light can be transmitted downward through the lower polarizer sheet 403. At this point, the phase retardation value of the phase retardation plate is an odd multiple of one-half wavelength (preferably, one-half wavelength), and the three methods for adjusting the optical axis direction of the phase retardation plate are shown. 1) When the optical axis of the phase retardation plate 402 and the transmission axis of the lower polarizer sheet 403 of the display panel form an angle of 0° or 90°, a linearly polarized light through the lower polarizer sheet 403 passes through the phase retardation plate 402 at the time, the polarization direction thereof will not be changed, thus the linearly polarized light will be directly transmitted through the second reflective polarizer sheet 401 below again. At the same time, for a light from the backlight source, when it first reaches the second reflective polarizer sheet 401, only a linearly polarized light with a polarization direction parallel to the transmission axis of the second reflective polarizer sheet 401 can pass through, and then the linearly polarized light again passes through the phase retardation plate 402, and at this point the optical axis of the phase retardation plate and the transmission axis of the lower polarizer sheet form an angle of 0° or 90°, the linearly polarized light through the second reflective polarizer sheet may be directly transmitted through the phase retardation film 402, and because the transmission axis of the lower polarizer sheet will be parallel to the transmission axis of the second reflective polarizer sheet, the linearly polarized light may be also directly transmitted through the lower polarizer sheet, so that the full transmission may be realized without any reflection. 2) When the optical axis of the phase retardation plate 402 and the transmission axis of the lower polarizer sheet 403 of the display panel form an angle of 45°, after the linearly polarized light passes through the phase retardation plate, the polarization direction thereof will be rotated by 90°, thus for an external light reaching the lower polarizer sheet, only a linearly polarized light with a polarization direction parallel to the transmission axis of the lower polarizer sheet can be transmitted through the lower polarizer sheet, and after the linearly polarized light passes through the phase retardation plate, the polarization direction of the linearly polarized light will be vertical to the transmission axis of the second reflective polarizer sheet, and the linearly polarized light will be reflected by the second reflective polarizer sheet at this point, the reflected linearly polarized light passes through the phase retardation plate again, and the polarization direction of the linearly polarized light will be rotated by 90°, and because the polarization direction of the linearly polarized light will be parallel to the transmission axis of the lower polarizer sheet at this point, the linearly polarized light may pass through the lower polarizer sheet again, thereby passing through the liquid crystal panel. At the same time, after reaching the second reflective polarizer sheet and the phase retardation plate, the light from the backlight source will become a linearly polarized light with a polarization direction vertical to the transmission axis of the lower polarizer sheet, thus the linearly polarized light cannot be transmitted through the lower polarizer sheet, and the full reflective mode may be realized. 3) When the optical axis of the phase retardation plate 402 and the transmission axis of the lower polarizer sheet 403 of the display panel form an angle other than 0°, 45° or 90°, the transflective mode will be realized.

3. The transmission axis of the second reflective polarizer sheet 401 is kept vertical to the transmission axis of the lower polarizer sheet 403 of the display panel, the optical axis of the phase retardation plate 402 and the transmission axis of the second reflective polarizer sheet form an angle of 45°, and the transmission-reflection ratio of the display panel is adjusted by controlling the phase retardation value of the phase retardation plate 402, thereby the mode conversion (comprising the full transmissive mode, the transflective mode and the full reflective mode) can be achieve. In this Example, when the phase retardation value of the phase retardation plate 402 is 0 or an integral multiple of the wavelength (i.e. R=nλ, preferably R=0), the display panel will be in the full reflective mode; when the phase retardation value is an odd multiple of one-half wavelength (i.e. R=(2n+1)λ/2, preferably, R is equal to one-half wavelength), the display panel will be in the full transmissive mode; and when the phase retardation value is other values (i.e. nλ<R<(2n+1)λ/2 or (2n+1)λ/2<R<(n+1)λ/2), the display panel will be in the transflective mode, and the transmission-reflection proportion will be determined by the phase retardation value.

The operating principle thereof will be as follows: when the outside ambient light is strong, in the ambient light, only a light with a polarization state parallel to the transmission axis of the lower polarizer sheet 403 can be transmitted downward through the lower polarizer sheet 403, and then the polarized light passes through the phase retardation plate 402, of which the optical axis and the polarization direction of the polarized light form an included angle of 45°. At this point, the adjustment to the phase retardation value of the phase retardation plate may have specifically the following three cases. 1) when the phase retardation value of the phase retardation plate 402 is equal to 0 or an even multiple of one-half wavelength, and a linearly polarized light through the lower polarizer sheet 403 passes through the phase retardation plate 402, the polarization direction thereof will not be changed, thus it will be fully reflected when reaching the reflective polarizer sheet below, then it again passes through the phase retardation plate 402, and the polarization direction will still not be changed, and at this point the polarization direction is parallel to the transmission axis of the lower polarizer sheet, so that the light will fully pass through; at the same time, when a light from the backlight source passes through the second reflective polarizer sheet, only a linearly polarized light with a polarization direction parallel to the transmission axis of the second reflective polarizer sheet can pass through, and this part of linearly polarized light can also directly pass through the phase retardation plate, but it cannot pass through the lower polarizer sheet, thus the full reflective mode may be realized. 2) When the phase retardation value of the phase retardation plate 402 is an odd multiple of one-half wavelength (preferably, one-half wavelength), the polarization state of a linearly polarized light passing through the phase retardation plate will be rotated by 90°, and at this point the polarization state of a linearly polarized light is just parallel to the transmission optical axis of the reflective polarizer sheet below, and the light will be fully transmitted, without any reflection; at the same time, when a light from the backlight source passes through the second reflective polarizer sheet, only a linearly polarized light with a polarization direction parallel to the transmission axis of the second reflective polarizer sheet can be transmitted, and after passing through the phase retardation plate, the polarization direction of the linearly polarized light will be rotated by 90°, so that it can pass through the lower polarizer sheet, thereby the full transmissive mode may be realized. 3) When the phase retardation value of the phase retardation plate 402 is a value other than the above two cases, the transflective mode may be realized.

4) The transmission axis of the second reflective polarizer sheet is kept vertical to the transmission axis of the lower polarizer sheet 403 of the display panel, the phase retardation value of the phase retardation plate 402 is an odd multiple of one-half wavelength (preferably, one-half wavelength), and the transmissive and reflective state and the transmission-reflection proportion are realized by controlling the optical axis of the phase retardation plate 402, thereby the mode conversion (comprising the full transmissive mode, the transflective mode and the full reflective mode) can be achieve. In this Example, when the optical axis of the phase retardation plate and the transmission axis of the second reflective polarizer sheet form an angle of 0° or 90°, the display panel will be in the full reflective mode; when the optical axis of the phase retardation plate and the transmission axis of the second reflective polarizer sheet form an angle of 45°, the display panel will be in the full transmissive mode; and when the optical axis of the phase retardation plate and the transmission axis of the second reflective polarizer sheet form an angle other than 0°, 45° or 90°, the display panel will be in the transflective mode, and the transmission-reflection proportion will be determined by the size of the angle.

The operating principle thereof will be as follows. When the outside ambient light is strong, only a linearly polarized light with a polarization state parallel to the transmission axis of the lower polarizer sheet 403 in the ambient light can be transmitted downward through the lower polarizer sheet 403. At this point, the phase retardation value of the phase retardation plate is an odd multiple of one-half wavelength (preferably, one-half wavelength), and the adjustment to the optical axis of the phase retardation plate may have specifically the following three cases. 1) When the optical axis of the phase retardation plate 402 and the transmission axis of the lower polarizer sheet 403 of the display panel form an angle of 0° or 90°, a linearly polarized light through the lower polarizer sheet 403 passes through the phase retardation plate 402 at the time, the polarization direction thereof will not be changed, thus the linearly polarized light will be fully reflected when reaching the reflective polarizer sheet below again, then it again passes through the phase retardation plate 402, and the polarization direction thereof will not be changed, so that the light will be fully transmitted through the lower polarizer sheet 403; at the same time, for a light from the backlight source, when reaching the second reflective polarizer sheet, only a linearly polarized light with a polarization direction parallel to the transmission axis of the second reflective polarizer sheet can be transmitted through the second reflective polarizer sheet, and the linearly polarized light can directly pass through the phase retardation plate, but it cannot pass through the lower polarizer sheet, thus the full reflective mode of the display panel may be realized. 2) When the optical axis of the phase retardation plate 402 and the transmission axis of the display panel form an angle of 45°, after a linearly polarized light passes through the phase retardation plate 402, the polarization state of a linearly polarized light will be rotated by 90°, and at this point, the polarization state of the polarized light is just parallel to the transmission optical axis of the reflective polarizer sheet below, and the light will be fully transmitted; at the same time, when a light from the backlight source reaches the second reflective polarizer sheet, only a linearly polarized light with a polarization direction parallel to the transmission axis of the second reflective polarizer sheet can be transmitted, and after passing through the phase retardation plate, the polarization direction of the linearly polarized light will be rotated by 90, so that it can pass through the lower polarizer sheet, thereby the full transmissive mode may be realized. 3) When the optical axis of the phase retardation plate 402 and the transmission axis of the display panel form an angle other than 0°, 45° or 90°, the transflective mode will be realized.

However, there are also other adjusting methods in the invention in addition to the above four methods. In the above four methods, the mode switch between different modes is mainly realized by fixing one of the two parameters, i.e., the phase retardation value and the optical axis direction of the phase retardation plate, and adjusting the other parameter. the mode switch between different modes can also be realized by adjusting both the phase retardation value and the optical axis direction of the phase retardation plate 402 at the same time according to the requirements of the display panel design, so long as the adjustment meet one of the method described above.

It may be seen from this Example that, for the transflective film with an adjustable transmission-reflection ratio, in the invention, a free switch between the full transmissive mode, the full reflective mode and the transflective mode of a display device may be realized by adjusting the transmission-reflection ratio of the transflective film with an adjustable transmission-reflection ratio, for example, by adjusting the phase retardation value and/or the optical axis direction of the adjustable phase retardation plate, so that the display panel may be used flexibly.

### Example 4

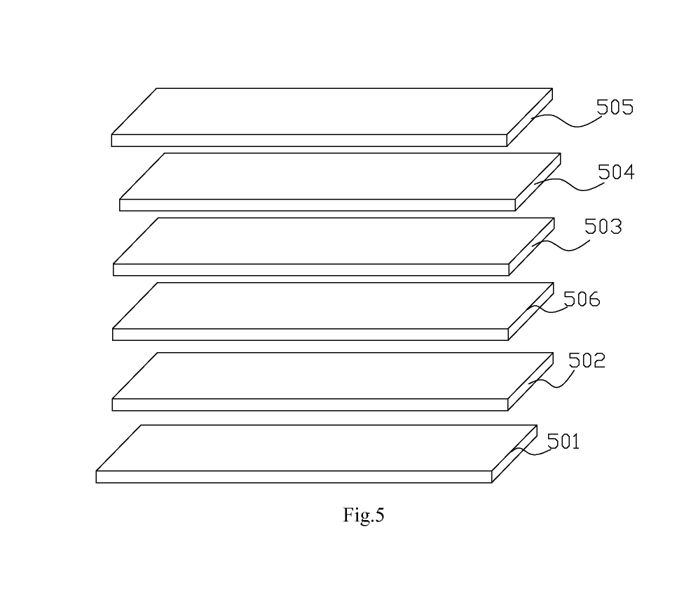

As shown in FIG. 5, the structure of the display panel according to this Example is basically the same as that of Example 3, which comprises an upper polarizer sheet 505, a liquid crystal cell 504, a lower polarizer sheet 503 and a transflective film, wherein the upper polarizer sheet 505, the liquid crystal cell 504, the lower polarizer sheet 503 and the transflective film are arranged in turn from top to bottom, and the difference is that a third reflective polarizer sheet 506 is further provided between the transflective film and the lower polarizer sheet 503, and the transmission axis of the third reflective polarizer sheet 506 is parallel to the transmission axis of the lower polarizer sheet 503 in this embodiment.

In FIG. 5 of this Example, it only shows an example in which the transflective film is the phase retardation plate 502 and the second reflective polarizer sheet 501. But in fact, the third reflective polarizer sheet 506 may be provided in both Embodiment 1 and Embodiment 2.

In the case that the third reflective polarizer sheet 506 is not provided, when the ambient light reaches the lower polarizer sheet 503, only a light with a polarization direction parallel to the lower polarizer sheet 503 can be transmitted, while a light with a polarization direction non-parallel to the lower polarizer sheet 503 will be absorbed. After the third reflective polarizer sheet 506 is provided, the light that cannot be transmitted will be reflected back by the third reflective polarizer sheet 506 instead of being absorbed, because reflecting and scattering parts exist in the backlight module, the reflected linearly polarized light will contain a plurality of linearly polarized lights having different polarization directions after being reflected and scattered by the backlight module, and a part of these linearly-polarized lights can be reutilized and again pass through the third reflective polarizer sheet, when the linearly polarized lights reach the lower polarizer sheet 503 again, due to the change of the polarization state, they may be transmitted upward through the lower polarizer sheet 503, thereby the utilization rate of the light can be improved.

### Example 5

This Example records a display device, which comprises the display panel according to any one of Example 1-4, and a backlight module arranged under the display panel.

The display device according to this Example may be a product or a component with a display function, for example, a liquid crystal panel, a electronic paper, an organic light-emitting diode (OLED) panel, a liquid crystal TV, a liquid crystal display, a digital photo frame, a mobile phone and a flat panel computer, etc.

In the invention, a transflective display is realized without changing the structure of the traditional liquid crystal cell, thus not only the transflective display has an improved effect, for example, without the problems of poor visual angle and low contrast, while with an effect the same as or better than that of a general transmissive mode and a good stability in outdoor, but also the transflective display has a simple structure and an inexpensive cost in comparison with the existing transflective display mode.

The above embodiments are only used to illustrate the invention, rather than limiting the invention; various variations and modifications may also be made by one of ordinary skills in the art without departing from the spirit and scope of the invention, therefore, all the equivalent technical solutions pertain to the protection scope of the invention as defined by the appended claims.

What is claimed is:

1. A display panel comprising a liquid crystal cell, an upper polarizer sheet arranged above the liquid crystal cell, a lower polarizer sheet arranged under the liquid crystal cell, and a transflective film arranged under the lower polarizer sheet.

2. The display panel according to claim 1, wherein the transflective film comprises a first reflective polarizer sheet, wherein an included angle formed between transmission axis of the first reflective polarizer sheet and transmission axis of the lower polarizer sheet is an acute angle.

3. The display panel according to claim 1, wherein the transflective film comprises a phase retardation plate and a second reflective polarizer sheet under the phase retardation plate.

4. The display panel according to claim 3, wherein the phase retardation plate is an adjustable phase retardation plate having adjustable phase retardation value and/or optical axis direction.

5. The display panel according to claim 3, wherein transmission axis of the second reflective polarizer sheet is parallel to or vertical to transmission axis of the lower polarizer sheet.

6. The display panel according to claim 3, wherein transmission axis of the second reflective polarizer sheet is parallel to transmission axis of the lower polarizer sheet, optical axis of the phase retardation plate and the transmission axis of the second reflective polarizer sheet form an angle of 45°, and a mode conversion between a full transmissive mode, a transflective mode and a full reflective mode can be achieved in the display panel by controlling phase retardation value of the phase retardation plate.

7. The display panel according to claim 6, wherein when R is equal to nλ, the display panel is in the full transmissive mode; when R is equal to (2n+1) λ/2, the display panel is in the full reflective mode; and when R is greater than nλ and less than (2n+1) λ/2, or greater than (2n+1) λ/2 and less than (n+1) λ, the display panel is in the full transflective mode;
wherein R represents the phase retardation value of the phase retardation plate, λ represents wavelength of incident light, and n represents 0 or a positive integer.

8. The display panel according to claim 3, wherein transmission axis of the second reflective polarizer sheet is parallel to transmission axis of the lower polarizer sheet, phase retardation value of the phase retardation plate is an odd multiple of one-half wavelength, and a mode conversion between a full transmissive mode, a transflective mode and a full reflective mode can be achieved in the display panel by adjusting optical axis direction of the phase retardation plate.

9. The display panel according to claim 8, wherein when the optical axis of the phase retardation plate and the transmission axis of the second reflective polarizer sheet form an angle of 0° or 90°, the display panel is in the full transmissive mode; when the optical axis of the phase retardation plate and the transmission axis of the second reflective polarizer sheet form an angle of is 45°, the display panel is in the full reflective mode; and when the optical axis of the phase retardation plate and the transmission axis of the second reflective polarizer sheet form an angle of is greater than 0° and less than 45°, or greater than 45° and less than 90°, the display panel is in the transflective mode.

10. The display panel according to claim 3, wherein transmission axis of the second reflective polarizer sheet is vertical to transmission axis of the lower polarizer sheet, optical axis of the phase retardation plate and the transmission axis of the second reflective polarizer sheet form an angle of 45°, and a mode conversion between a full transmissive mode, a transflective mode and a full reflective mode can be achieved in the display panel by controlling phase retardation value of the phase retardation plate.

11. The display panel according to claim 8, wherein when R is equal to nλ, the display panel is in the full reflective mode; when R is equal to (2n+1) λ/2, the display panel is in the full transmissive mode; and when R is greater than nλ and less than (2n+1) λ/2, or greater than (2n+1) λ/2 and less than (n+1) λ, the display panel is in the full transflective mode;
wherein R represents the phase retardation value of the phase retardation plate, λ represents wavelength of incident light, and n represents 0 or a positive integer.

12. The display panel according to claim 3, wherein transmission axis of the second reflective polarizer sheet is vertical to transmission axis of the lower polarizer sheet, phase retardation value of the phase retardation plate is an odd multiple of one-half wavelength, and a mode conversion between a full transmissive mode, a transflective mode and a full reflective mode can be achieved in the display panel by adjusting optical axis direction of the phase retardation plate.

13. The display panel according to claim 12, wherein when the optical axis of the phase retardation plate and the transmission axis of the second reflective polarizer sheet form an angle of 0° or 90°, the display panel is in the full reflective mode; when the optical axis of the phase retardation plate and the transmission axis of the second reflective polarizer sheet form an angle of is 45°, the display panel is in the full transmissive mode; and when the optical axis of the phase retardation plate and the transmission axis of the second reflective polarizer sheet form an angle of is greater than 0° and less than 45°, or greater than 45° and less than 90°, the display panel is in the transflective mode.

14. The display panel according to claim 1, wherein the transflective film is made of a polymer dispersed liquid crystal.

15. The display panel according to claim 1, wherein, a third reflective polarizer sheet is further provided between the transflective film and the lower polarizer sheet, and transmission axis of the third reflective polarizer sheet is parallel to transmission axis of the lower polarizer sheet.

16. A display device comprising the display panel according to claim 1.
